(19) United States
(12) Patent Application Publication
(10) Pub. No.: US 2009/0102300 A1
(43) Pub. Date: Apr. 23, 2009

(54) Spindle motor for a hard disk drive

(76) Inventors: Thilo Rehm, Villingen-Schwenningen (DE); Olaf Winterhalter, Epfendorf (DE); Hiroshi Yoshikawa, Kitasaku-gun (JP); Toshimitsu Horiuchi, Kitasaku-gun (JP)

Correspondence Address: COOPER & DUNHAM, LLP, 30 Rockefeller Plaza, 20th Floor, NEW YORK, NY, 10112, US

(21) Appl. No.: 11/975,433

(22) Filed: Oct. 19, 2007

(51) Int. Cl. H02K 7/09; G11B 17/02; H02K 7/08

(52) U.S. Cl. 310/90; 360/99.08

(57) ABSTRACT

The invention relates to a spindle motor for a hard disk drive comprising a baseplate (1), a shaft (2) fixedly connected to the baseplate (1), a thrust plate (3) fixedly connected to the free end of the shaft, a bearing bush (4) disposed about the shaft (2) and the thrust plate (3) and rotatably supported with respect to these components, a bearing gap (5) that is provided between the adjoining surfaces of the shaft (2), the bearing bush (4) and the thrust plate (3), at least one radial bearing (6; 7) formed by the adjoining surfaces of the shaft (2) and the bearing bush (4), an axial bearing (8) formed by the adjoining surfaces of the thrust plate (3) and the bearing bush (4), an annular rotor component (9) connected to the bearing bush (4), and an electromagnetic drive system having a rotor magnet (11) fixed to a rotating component and a stator arrangement (12) disposed on the baseplate (1) opposite the rotor magnet (11).

### BACKGROUND OF THE INVENTION

The invention relates to a spindle motor for a hard disk drive, particularly a spindle motor having a fluid dynamic bearing arrangement

These kinds of spindle motors for hard disk drives comprise a baseplate or a base flange, a shaft and a bearing system to rotatably support a rotary-driven rotor. The bearing system may take the form of roller bearings or of fluid dynamic sliding bearings.

### PRIOR ART

Embodiments of spindle motors having a rotating or a stationary shaft are known. If the shaft is stationary, it is generally fixedly connected to the baseplate or to the base flange using an interference fit. For this purpose, the baseplate or the base flange has a bore having a specific diameter and a specific length into which one end of the shaft is pressed. The shaft is enclosed by a bearing bush that is rotatably supported with respect to the shaft by means of at least one radial bearing. The bearing bush forms a part of the rotor which has a hub that carries the storage disks and the magnets of an electromagnetic drive system. Axial displacement of the shaft is prevented by appropriate axial bearings.

Known motors, as revealed for example, in DE 201 19 716 U1, have a single or a multi-part rotor hub formed as a turned part, which not only makes it very heavy but also relatively expensive to manufacture

### BACKGROUND OF THE INVENTION

The object of the invention is to provide a spindle motor for driving a hard disk drive which is lightweight and very easy to construct, and which can be manufactured at low cost.

This object has been achieved according to the invention by the characteristics of claim 1.

Beneficial embodiments of the invention are cited in the subordinate claims.

The spindle motor according to the invention comprises a baseplate, a shaft, a thrust plate fixedly attached to a free end of the shaft, a bearing bush disposed about the shaft and the thrust plate and rotatably supported with respect to these components, a bearing gap that is provided between the adjoining surfaces of the shaft, the bearing bush and the thrust plate, at least one axial bearing formed by the adjoining surfaces of the thrust plate and the bearing bush, a rotor component connected to the bearing bush and an electromagnetic drive system having a rotor magnet fixed to a rotating component and a stator arrangement disposed on the baseplate opposite the rotor magnet.

In contrast to the prior art, a simple, easily manufactured, annular or bell-shaped rotor component finds application in the spindle motor according to the invention. The rotor magnet can be fastened to this rotor component by means of a yoke made of sheet metal.

In a first embodiment of the invention, the yoke plate consists of a cup-shaped or angled deep-drawn part having a radially extending annular section and an axially extending cylinder-shaped section. The yoke plate is fixed at its radially extending section to a lower end face of the rotor component, by using such means as bonding.

In another embodiment of the invention the yoke plate consists of an approximately cylinder-shaped sheet metal part that is fixed at an inner circumferential surface to an outer circumferential surface of the rotor component.

In both of the two described embodiments, the yoke plate forms an annular space in which the electromagnetic drive system of the motor is situated. The rotor magnet is disposed on an inner circumferential surface of the yoke plate, while a stator arrangement fixed to the baseplate lies opposite and radially inwards of the rotor magnet commensurate with an outer rotor motor.

An advantage of the present invention is to be found in the low manufacturing costs for the rotor component and for the yoke plate. The annular rotor component is particularly easy to manufacture and to machine. Similarly, the yoke plate can be easily manufactured at low-cost as a deep-drawn part that needs no further finishing process.

The known rotor hubs manufactured as turned parts are expensive to produce and require a costly finishing process to ensure that they meet the necessary tolerances.

A further advantage of the invention lies in the fact that the mass of the rotating parts of the spindle motor is thus reduced, particularly the mass of the annular rotor component and the yoke plate. A smaller mass means that the electromagnetic drive system can be given a weaker construction and the energy consumption of the motor distinctly reduced accordingly.

In order to achieve even greater savings in terms of cost and weight, according to another embodiment of the invention the yoke plate can be omitted entirely. Here, the rotor magnet is fixed directly to an outer circumferential surface of the bearing bush below the rotor component and is enclosed by the stator arrangement, with an air gap being simultaneously formed. In another non-illustrated embodiment, an annular yoke plate can be disposed between the rotor magnet and the bearing bush. The stator arrangement is fixed at its outside circumference to the baseplate in accordance with an inner rotor motor.

The rotor component is preferably fixed approximately in the middle of the outside circumference of the bearing bush. A part of the bearing bush projects beyond the upper face of the rotor component, so that at least one storage disk of the hard disk drive can be fixed to the upper end face. The bearing bush has an annular recess in its outside circumference for the purpose of securing the storage disk to the rotor component, the annular recess being disposed at a spacing to the upper face of the rotor component. A clamp for securing the storage disk to the rotor component can be engaged into this annular groove.

In a further preferred embodiment of the invention, the thrust plate is accommodated in a recess in the bearing bush, the recess being sealed by a cover. This means that no bearing fluid can escape from the bearing gap in this region and soil the storage disk, for example.

The thrust plate forms an axial bearing together with the bearing bush. This axial bearing is supported by a magnetic axial bearing that is formed by the rotor magnet and the stator arrangement being offset with respect to each other. In this embodiment, the cover does not have a bearing function, but is only used to seal the bearing.

In a further embodiment, a double-sided fluid axial bearing is used. For this purpose, a second axial bearing is formed between the inner side of the cover and the topside of the thrust plate.

At its outside circumference, the bearing bush can have a groove and a spring washer disposed therein which acts as an axial stop for the rotor component.

The subject matter of the present invention is not only derived from the subject matter of the individual patent claims but also from the combination of the individual patent claims. All details and characteristics revealed in the documents, particularly the spatial construction illustrated in the drawings, are claimed as being fundamental to the invention, either individually or in any combination, to the extent that they are new with respect to the prior art.

### BRIEF DESCRIPTION OF THE DRAWINGS

Several embodiments of the invention are described in more detail below on the basis of the figures in the drawings.

FIG. 1 shows a section through a spindle motor for hard disk drives in a first embodiment having a cup-shaped yoke plate.

FIG. 2 shows a section through a spindle motor for hard disk drives in a second embodiment having a cylindrical yoke plate.

FIG. 3 shows a section through a third embodiment of a spindle motor for hard disk drives without a yoke plate.

FIG. 4 shows a section through a spindle motor for hard disk drives in a fourth embodiment having a substantially cylindrical yoke plate.

FIG. 5 shows a section through a spindle motor for hard disk drives in a fifth embodiment having a rotating shaft and a substantially cylindrical yoke plate.

FIG. 6 shows a section through a spindle motor for hard disk drives in a sixth embodiment having a rotating shaft and a substantially cylindrical yoke plate.

FIG. 7 shows a section through a spindle motor for hard disk drives in a seventh embodiment having a rotating shaft and an angled yoke plate.

### DESCRIPTION OF PREFERRED EMBODIMENTS OF THE INVENTION

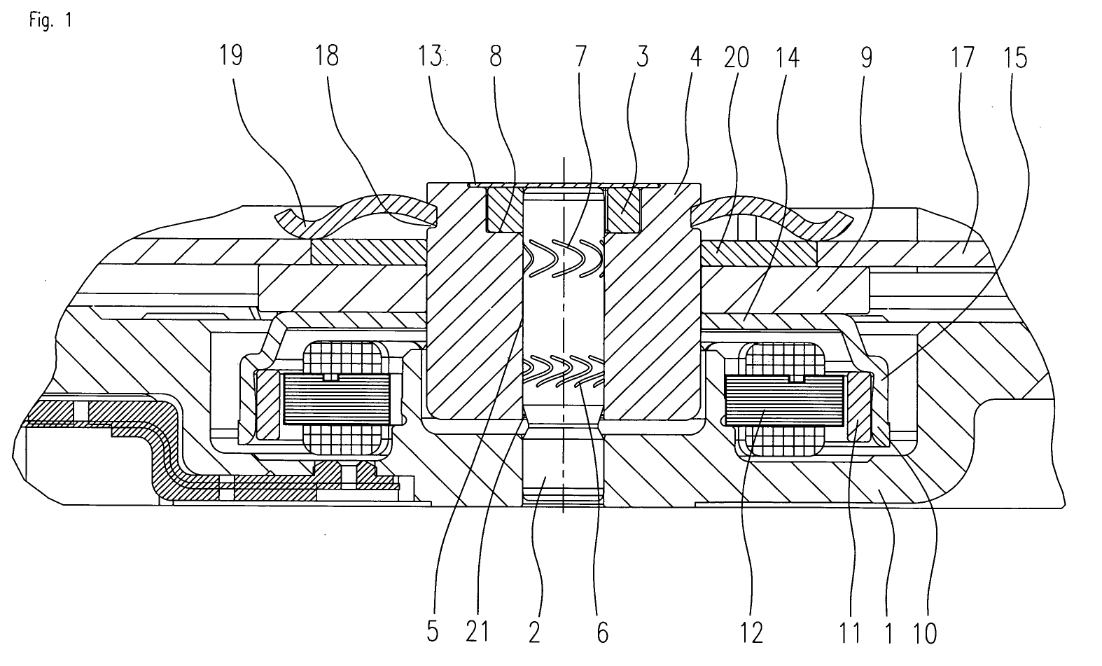

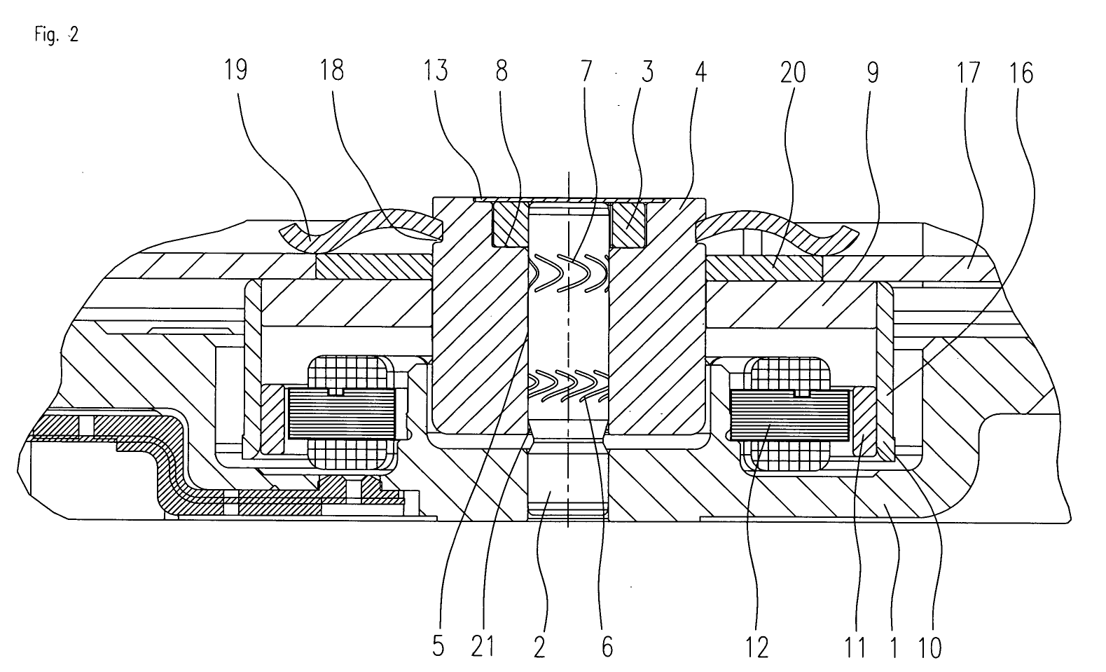

The spindle motors shown in FIGS. 1 and 2 are identical in construction except for the design of the yoke plate. Hence, the following general description of the spindle motor refers to both illustrated embodiments, wherein identical components are given the same reference numbers.

The spindle motor comprises a baseplate 1 and a shaft 2 fixedly connected to the baseplate. A bearing bush 4 is rotatably supported on the shaft 2 via a bearing system designed as a hydrodynamic sliding bearing. By way of example, the bearing system comprises two radial bearings 6, 7 as well as an axial bearing 8 that is formed by the axially opposing surfaces of the bearing bush 4 and a thrust plate 3 connected to the shaft. The components 2, 3, 4 journaled with respect to each other are separated from one another by a bearing gap 5 filled with a bearing fluid. The bearing system is sealed towards the outside by means of a cover 13. The cover 13 can be connected to the bearing bush 4 by such means as bonding, using an interference fit or by welding.

A tapered capillary seal 21, which can be molded into the shaft 2 and/or alternatively into the bearing bush 4, is provided at the end of the shaft that protrudes from the bearing bush 4.

An annular rotor component 9 is fixed approximately in the middle of the outside circumference of the bearing bush. A part of the bearing bush 4 projects beyond the upper face of the rotor component 9. At least one storage disk 17 of the hard disk drive can be secured to the upper planar surface of the rotor component. The bearing bush 4 has an annular recess 18 in its outside circumference for the purpose of securing the storage disk 17 to the rotor component 9, the annular recess being disposed at a spacing to the upper face of the rotor component 9. An annular clamp 19, taking the form, for example, of a spring washer, can be engaged into this annular recess 18, the annular clamp pressing the storage disk 17 onto the surface of the rotor component rendering it thus immovable. The storage disk 17 may abut the bearing bush 4 directly; additionally, a spacer ring 20 can be provided between the storage disk 17 and the bearing bush 4.

In the embodiment of the invention shown in FIG. 1, the yoke plate 10 consists of a cup-shaped deep-drawn part having a radially extending annular section 14 and an axially extending, approximately cylindrical section 15. This yoke plate 10 is fixed at its radially extending section 14 to a lower face of the rotor component 9, using such means as bonding. The cylindrical section of the yoke plate 10 defines an annular space in which the electromagnetic drive system of the motor, consisting of a rotor magnet 1 1 and a stator arrangement 12, is situated. The rotor magnet 11 is disposed on an inner circumferential surface of the yoke plate 10, while the stator arrangement 12 fixed to the baseplate 1 lies opposite and radially inwards of the rotor magnet 11. An alternating electric field can be applied to the stator arrangement 12 in a conventional manner, the alternating electric field acting on the rotor magnet 11 and setting the rotor, and thus the storage disk 17 as well, into rotation.

In the embodiment of the invention shown in FIG. 2, the yoke plate 16 consists of a cylindrical sheet metal part that is fixed at an inner circumferential surface to an outer circumferential surface of the rotor component 9. The projecting section of the yoke plate 16 defines an annular space in which the electromagnetic drive system of the motor, consisting of the rotor magnet 11 and the stator arrangement 12, is situated. The rotor magnet 11 is disposed on an inner circumferential surface of the yoke plate 16, while the stator arrangement 12 fixed to the baseplate 1 lies opposite and radially inwards of the rotor magnet 11.

The rotor magnet 11 and the stator arrangement are offset with respect to each other in an axial direction, thus producing a magnetic force in the direction of the rotor component 9. This axially directed force, created by the magnetic offset of the drive system, acts as a magnetic axial bearing which, functioning as a counter bearing, supports the fluid dynamic axial bearing 8. The rotor component 9 is preferably a stamped part that can be made, for example, of aluminum.

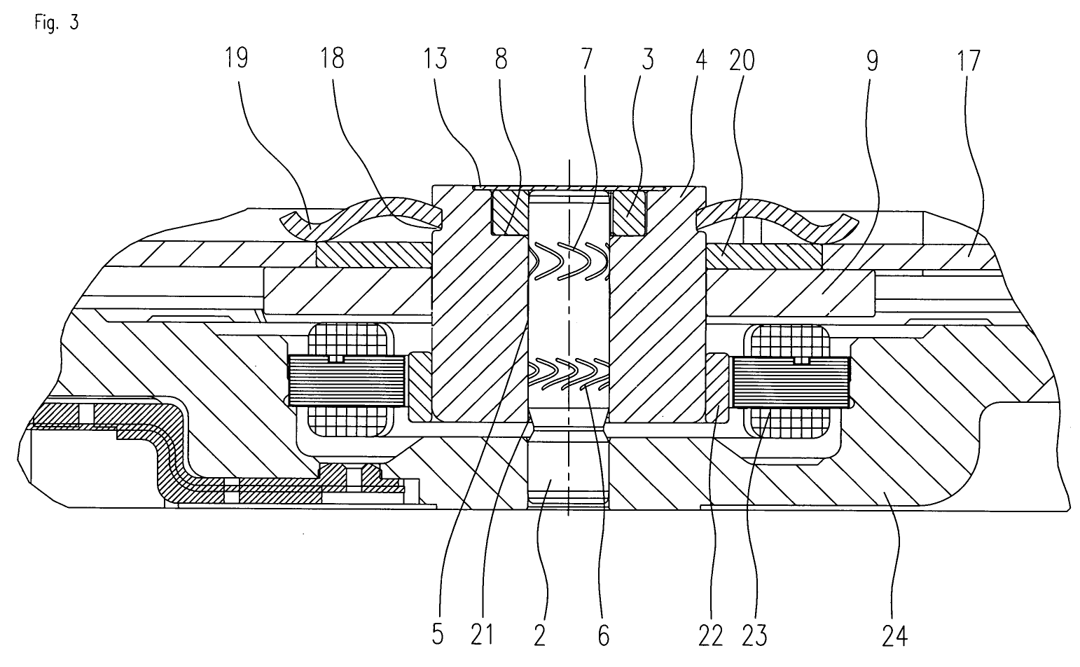

The spindle motor shown in FIG. 3 is substantially identical to the spindle motors of FIGS. 1 and 2. Hence, identical components are indicated by the same reference numbers. In contrast to FIGS. 1 and 2, the motor shown in FIG. 3 does not have a yoke plate, which means that there are additional cost savings compared to the other embodiments of the invention.

Instead of being fixed to a yoke plate, the rotor magnet 22 is fixed to an outer circumferential surface of the bearing bush 4 below the rotor component 9, the bearing bush 4 taking on the task of a yoke and ensuring the magnetic return. An air gap is formed as the rotor magnet 22 is enclosed by a stator arrangement 23 that is fixed at its outside circumference to the baseplate 24. The rotor magnet 22 and the stator arrangement 23 are preferably offset in an axial direction with respect to one another, thus producing a magnetic offset and an effective force in the direction of the rotor component 9.

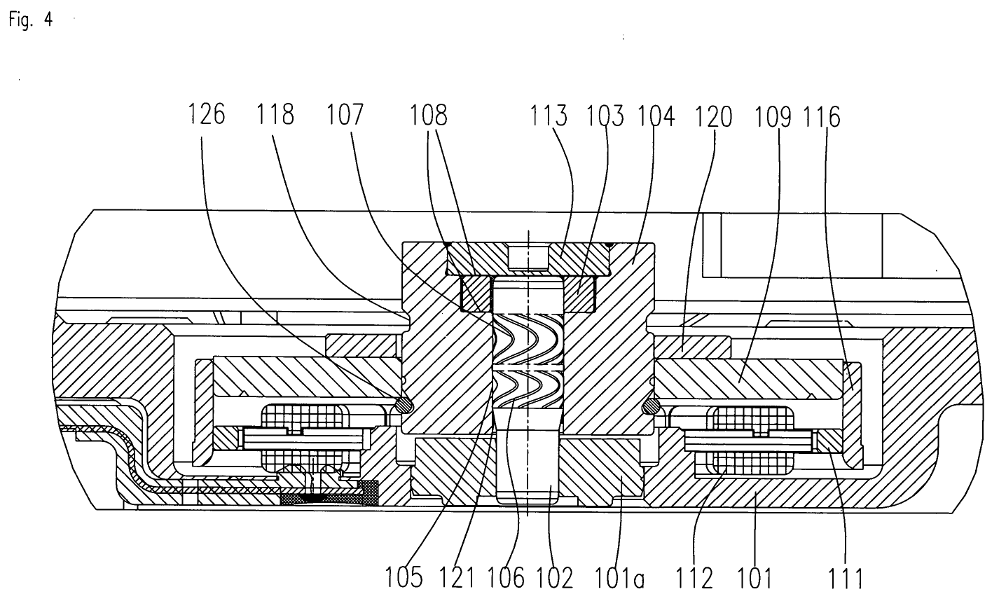

FIG. 4 shows an embodiment of a spindle motor according to the invention having a baseplate 101 that has a central bush 101a in which a shaft 102 is held. A bearing bush 104 is rotatably supported on the shaft 102 by means of a bearing system taking the form of a hydrodynamic sliding bearing. By way of example, the bearing system comprises two radial bearings 106, 107, as well as two axial bearings 108. The components 102, 103 and 104 journaled with respect to each other are separated from one another by a bearing gap 105 filled with a bearing fluid, such as a bearing oil. The bearing system is sealed towards the outside by means of a cover 113. The open end of the bearing gap 105 is sealed by means of a tapered capillary seal 121.

An annular rotor component 109 is fixed to the outside circumference of the bearing bush 104. The rotor component 109 is preferably a stamped part that can be made, for example, of aluminum. A part of the bearing bush 104 projects beyond the upper face of the rotor component 109. A storage disk (see FIG. 1) of the hard disk drive can be fixed to the upper planar surface of the rotor component 109. The bearing bush 104 has an annular recess 118 in its outside circumference for the purpose of securing the storage disk to the rotor component 109, the annular recess being disposed at a spacing to the upper face of the rotor component 109. An annular clamp (see FIG. 1), taking the form, for example, of a spring washer, can be engaged into this annular recess 118, the annular clamp pressing the storage disk onto the surface of the rotor component 109 thus rendering it immovable. A spacer ring 120 can be provided between the storage disk and the bearing bush 104.

A yoke plate 116 is fixed to the outside circumference of the rotor component 109, the yoke plate consisting substantially of a cylindrical sheet metal part. The projecting section of the yoke plate 116 defines an annular space in which the electromagnetic drive system of the motor, consisting of the rotor magnet 111 and the stator arrangement 112, is situated. The rotor magnet 111 is disposed on an inner circumferential surface of the yoke plate 116, while the stator arrangement 112 fixed to the baseplate 101 lies opposite and radially inwards of the rotor magnet 111.

Positioning the rotor component 109 on the circumference of the bearing bush 104 in an axial direction is facilitated by using a spring washer 126. The spring washer 126 acts as a stop when the rotor component 109 is slid onto the bearing bush 104.

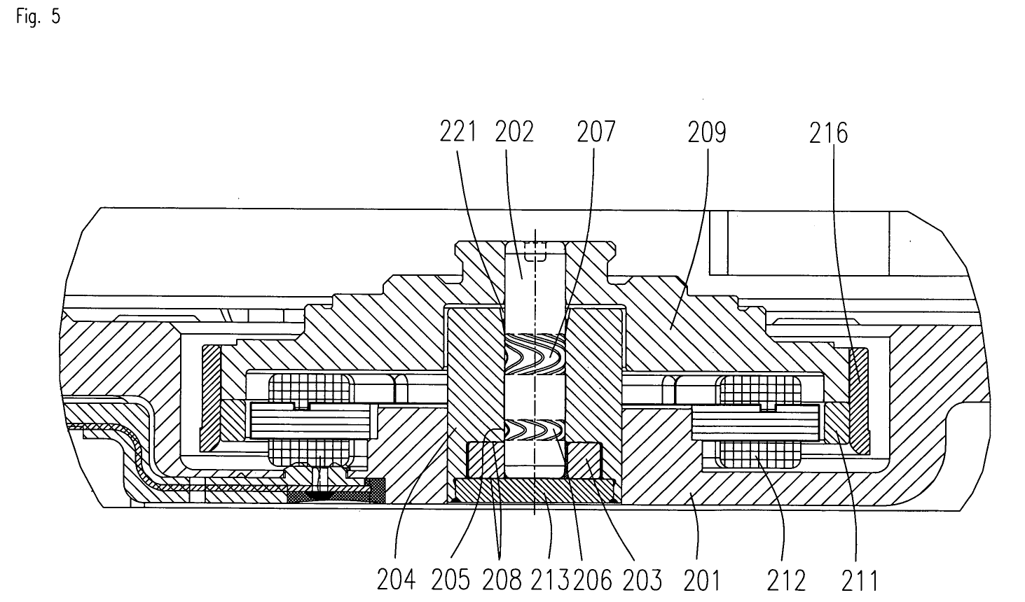

In FIG. 5, an embodiment of a spindle motor according to the invention is shown in which it is not the bearing bush 204 that rotates but rather the shaft 202. The spindle motor comprises a baseplate 201 in which the bearing bush 204 is fixedly accommodated. The shaft 202 is rotatably supported in a bore in the bearing bush 204 by means of a bearing system taking the form of a hydrodynamic sliding bearing. By way of example, the bearing system comprises two radial bearings 206, 207 as well as axial bearings 208 that are formed by a thrust plate 203 disposed in a recess in the bearing bush 204 and connected to the shaft 202. The components 202, 203 and 204 journaled with respect to each other are separated from one another by a bearing gap 205 filled with a bearing fluid, such as a bearing oil. The lower end of the bearing system is sealed towards the outside by means of a cover 213. The open end of the bearing gap 205 is sealed by means of a tapered capillary seal 221.

A bell-shaped or cup-shaped rotor component 209 is fixed to the free end of the shaft 202. A part of the bearing bush 204 is enclosed by the rotor component 209. A storage disk (see FIG. 1) of the hard disk drive can be fixed to an upper planar surface of the rotor component 209. An annular clamp can be used for the purpose of securing the storage disk to the rotor component 209, the clamp being fixed in a bore in the shaft 202 and pressing the storage disk onto the surface of the rotor component 209 rendering it thus immovable.

A yoke plate 216 is fixed to the outside circumference of the rotor component 209 on an outer annular rim, the yoke plate consisting substantially of a cylindrical sheet metal part. The rotor component 209 and a section of the yoke plate 216 projecting therefrom define an annular space in which the electromagnetic drive system of the motor, consisting of the rotor magnet 211 and the stator arrangement 212, is situated. The rotor magnet 211 is disposed on an inner circumferential surface of the yoke plate 216, while the stator arrangement 212 fixed to the baseplate 201 lies opposite and radially inwards of the rotor magnet 211.

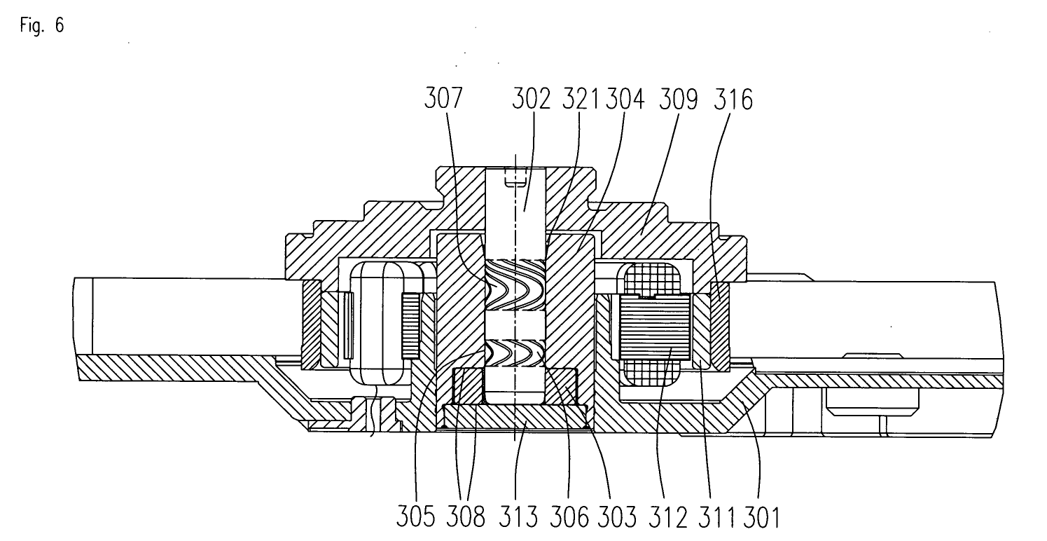

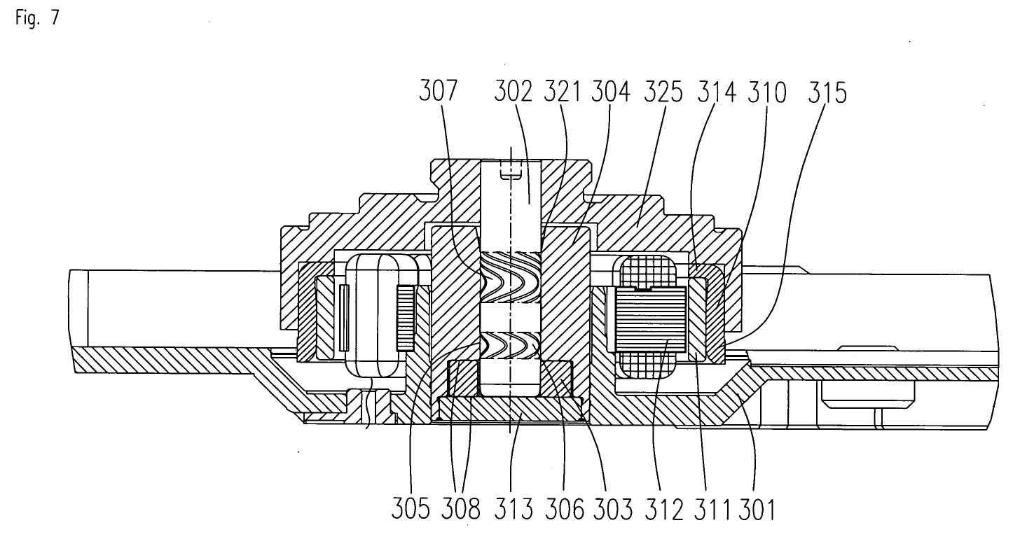

The spindle motors shown in FIGS. 6 and 7 are identical in construction except for the design of the yoke plate. Hence, the following general description of the spindle motor refers to both illustrated embodiments, wherein identical components are given the same reference numbers.

The spindle motor from FIGS. 6 and 7 comprises a baseplate 301 in which a bearing bush 304 is fixedly accommodated. A shaft 302 is rotatably supported in a bore in the bearing bush 304 by means of a bearing system taking the form of a hydrodynamic sliding bearing. B y way of example, the bearing system comprises two radial bearings 306, 307 as well as axial bearings 308 that are formed by a thrust plate 303 disposed in a recess in the bearing bush 304 and connected to the shaft 302. The components 302, 303 and 304 journaled with respect to each other are separated from one another by a bearing gap 305 filled with a bearing fluid, such as a bearing oil. The lower end of the bearing system is sealed towards the outside by means of a cover 313. The open end of the bearing gap 305 is sealed by means of a tapered capillary seal 321.

A bell-shaped or cup-shaped rotor component 309 is fixed to the free end of the shaft 302. A part of the bearing bush 304 is enclosed by the rotor component 309. A storage disk (see FIG. 1) of the hard disk drive can be fixed to an upper planar surface of the rotor component 309. An annular clamp can be used for the purpose of securing the storage disk to the rotor component 309, the clamp being fixed in a bore in the shaft 302 and pressing the storage disk onto the surface of the rotor component 309 rendering it thus immovable.

In the embodiment of the invention shown in FIG. 6, the yoke plate 316 consists of an approximately cylindrical sheet metal part that is fixed at an inner circumferential surface to an outer circumferential rim of the rotor component 309. The projecting section of the yoke plate 316 defines an annular space in which the electromagnetic drive system of the motor, consisting of the rotor magnet 311 and the stator arrangement 312, is situated. The rotor magnet 311 is disposed on an inner circumferential surface of the yoke plate 316, while the stator arrangement 312 fixed to the baseplate 301 lies opposite and radially inwards of the rotor magnet 311. The rotor component 309 is preferably a stamped part that can be made, for example, of aluminum.

In the embodiment of the invention shown in FIG. 7, the yoke plate 310 consists of an angled deep-drawn part having a radially extending annular section 314 and an axially extending, approximately cylindrical section 315. This yoke plate 310 is fixed at its radially extending section 314 to a lower face of the rotor component 309, such as by means of bonding. The cylindrical section 315 of the yoke plate 310 partially lies on a circumferential rim of the rotor component 309 and defines an annular space in which the electromagnetic drive system of the motor, consisting of a rotor magnet 311 and a stator arrangement 312, is situated.

### IDENTIFICATION REFERENCE LIST

1 Baseplate

2 Shaft

3 Thrust plate

4 Bearing bush

5 Bearing gap

6 Radial bearing

7 Radial bearing

8 Axial bearing

9 Rotor component

10 Yoke plate

11 Rotor magnet

12 Stator arrangement

13 Cover

14 Radial section (yoke plate)

15 Cylindrical section (yoke plate)

16 Yoke plate (cylindrical)

17 Storage disk

18 Recess

19 Clamp

20 Spacer ring

21 Capillary seal (tapered)

22 Rotor magnet

23 Stator arrangement

24 Baseplate

101 Baseplate

101a Bush

102 Shaft

103 Thrust plate

104 Bearing bush

105 Bearing gap

106 Radial bearing

107 Radial bearing

108 Axial bearing

109 Rotor component

110 Rotor magnet

111 Stator arrangement

112 Cover

113 Yoke plate (cylindrical)

114

115 Recess

116

117 Spacer ring

126 Spring washer

201 Baseplate

202 Shaft

203 Thrust plate

204 Bearing bush

205 Bearing gap

206 Radial bearing

207 Radial bearing

208 Axial bearing

209 Rotor component

210 Rotor magnet

211 Stator arrangement

212 Cover

213 Yoke plate (cylindrical)

221 Capillary seal (tapered)

301 Baseplate

302 Shaft

303 Thrust plate

304 Bearing bush

305 Bearing gap

306 Radial bearing

307 Radial bearing

308 Axial bearing

309 Rotor component

310 Yoke plate

311 Rotor magnet

312 Stator arrangement

313 Cover

314 Radial section (yoke plate 310)

315 Cylindrical section (yoke plate 310)

316 Yoke plate (cylindrical)

321 Capillary seal (tapered)

325 Rotor component

1. A spindle motor for a hard disk drive comprising a baseplate (1; 24; 101; 201; 301), a shaft (2; 102; 202; 302), a thrust plate (3; 103; 203; 303) fixedly connected to one end of the shaft, a bearing bush (4; 104; 204; 304) disposed about the shaft (2; 102; 202; 302) and the thrust plate (3; 103; 203; 303) and rotatably supported with respect to these components, a bearing gap (5) that is provided between the adjoining surfaces of the shaft (2; 102; 202; 302), the bearing bush (4; 104; 204; 304) and the thrust plate (3; 103; 203; 303), at least one radial bearing (6; 106; 206; 306, 7; 107; 207; 307) that is provided by the adjoining surfaces of the shaft (2; 102; 202; 302) and the bearing bush (4; 104; 204; 304), at least one axial bearing (8; 108; 208; 308) that is formed by the adjoining surfaces of the thrust plate (3; 103; 203; 303) and the bearing bush (4; 104; 204; 304), a rotor component (9; 109; 209; 309) connected to the bearing bush (4; 104; 204; 304), and an electromagnetic drive system having a rotor magnet (11, 111, 211, 311; 22) fixed to a rotating component and a stator arrangement (12, 112; 212; 212; 23) disposed on the baseplate (1; 24; 101; 201; 301) opposite the rotor magnet (11; 111; 211; 311).

2. A spindle motor according to claim 1, characterized in that a yoke plate (10; 310; 16; 116; 216) is disposed on the rotor component (9; 109; 209; 309), the rotor magnet (11; 111; 211; 311) being fixed to this yoke plate.

3. A spindle motor according to claim 2, characterized in that the yoke plate (10; 310) consists of a cup-shaped or angled deep-drawn part having a radially extending annular section (14; 314) and an axially extending cylinder-shaped section (15; 315).

4. A spindle motor according to claim 3, characterized in that the yoke plate (10; 310) is fixed at its radially extending section (14; 314) to a lower face of the rotor component (9; 309).

5. A spindle motor according to claim 1, characterized in that the yoke plate (16; 116; 216) consists of a substantially cylinder-shaped sheet metal part.

6. A spindle motor according to claim 5, characterized in that the yoke plate (16; 116; 216) is fixed at an inner circumferential surface to an outer circumferential surface of the rotor component (9; 109; 209).

7. A spindle motor according to claim 2, characterized in that the rotor magnet (11; 111; 211; 311) is disposed on an inner circumferential surface of the yoke plate (10; 310; 16; 116; 216).

8. A spindle motor according to claim 1, characterized in that the rotor magnet (22) is fixed to an outer circumferential surface of the bearing bush (4) below the rotor component (9).

9. A spindle motor according to claim 1, characterized in that the rotor magnet (22) is enclosed by the stator arrangement (23) while forming an air gap, the stator arrangement being fixed to the baseplate (24) at its outside circumference.

10. A spindle motor according to claim 1, characterized in that the rotor component (9; 109) is fixed approximately at the axial center of the bearing bush (4; 104).

11. A spindle motor according to claim 1, characterized in that the bearing bush (4; 104) has an annular recess (18; 118) at its outside circumference, the annular recess being disposed at a spacing to the upper face of the rotor component (9; 109).

12. A spindle motor according to claim 1, characterized in that an upper face of the rotor component (9; 109; 209; 309) is designed to receive at least one storage disk (17) of the hard disk drive.

13. A spindle motor according to claim 11, characterized in that the annular recess (18; 118) is designed to receive a clamp (19) for the purpose of securing the a storage disk (17) onto the rotor component (9; 109).

14. A spindle motor according to claim 1, characterized in that the thrust plate (3; 103; 203; 303) is disposed in a recess in the bearing bush (4; 104; 204; 304), the recess being sealed by a cover (13; 113; 213; 313).

15. A spindle motor according to claim 1, characterized in that the rotor magnet (11) and the stator arrangement (12) are offset with respect to each other and form a magnetic axial bearing

16. A spindle motor according claim 1, characterized in that the rotor component (9; 109) is ring-shaped.

17. A spindle motor according claim 1, characterized in that the rotor component (209; 309) is bell-shaped or cup-shaped.

18. A spindle motor according to claim 1, characterized in that the bearing bush (104) has a groove in its outside circumference and a spring washer (126) disposed therein that acts as an axial stop for the rotor component (109).
